(19) United States
(12) Patent Application Publication
(10) Pub. No.: US 2007/0161305 A1
(43) Pub. Date: Jul. 12, 2007

(54) Using chemicals to regulate functioning of ventilation points in a fabric or flexible substrate

(76) Inventor: Tanakorn Wangbunyen, Bangkok (TH)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 11/338,343

(22) Filed: Jan. 24, 2006

Related U.S. Application Data
(63) Continuation-in-part of application No. 11/329,494, filed on Jan. 10, 2006.

(51) Int. Cl. B32B 5/02; B32B 27/04; B32B 27/12; C11D 3/00; B32B 3/10

(52) U.S. Cl. 442/59; 442/79; 442/85; 442/86; 428/131; 8/115.51

(57) ABSTRACT

A process of providing ventilation points on a flexible substrate includes treating the flexible substrate with a chemical or a combination of chemicals that react to an environmental factor; and using that reaction to the environmental factor to regulate functioning of the ventilation points prepared on the substrate. A ventilated substrate includes ventilation points in the substrate; and a chemical or combination of chemicals applied to the substrate that regulate the ventilation points in response to an environmental factor.

### RELATED APPLICATIONS

The present application is a continuation-in-part of application Ser. No. 11/329,494, filed on Jan. 10, 2006, which application is incorporated by reference herein in their entirety.

### BACKGROUND

Different types of fabrics have different characteristics. Ability to breathe and moisture absorption are just some of the characteristic that the textile industry takes into consideration when producing fabric. For this reason, different fabrics are produced for use in different environments or weather conditions to provide maximum comfort to the user.

However, due to changes in the environment or weather conditions, or as a result of the user's activities, the characteristics of the fabric may still provide limited comfort. For instance, knitted fabrics are known to advantageously provide extra warmth in cool weather. This is because knitted fabrics experience relatively high moisture absorption. In cool weather, the fabric absorbs moisture and the fabric's filaments expand. As a result, there is less heat exchange between the ambient air outside the garment and the air inside the garment that is warmed by the wearer's body. Thus, the hot air is trapped inside and keeps the wearer warm. In warm weather, however, the same process can increase the wearer's discomfort. High humidity from the air may result in similar effects within the fabric. Consequently, the user feels even warmer and tends to sweat, thus, causing great discomfort. Other types of fabrics may be less sensitive to moisture absorption. However, due to user's activities, such as engaging in outdoor activities or playing sports, the exchange of hot air generated by body heat and the ambient air is not fast enough, again making the wearer sweat and causing discomfort.

There has been an attempt to increase air flow of the fabric or the clothing end product by reducing the size and number of threads when making the fabric or incorporating a net-like or open-meshed fabric into the article. The latter technique is predominant in sports wear and outdoor wear. These techniques improve the fabric's air flow to some extent, but there is room for improvement.

It is desirable for the fabric or clothing articles to breathe and adjust to changes in the air temperature, wearer's body temperature, or the weather conditions while providing maximum comfort to the wearer.

### SUMMARY

The present specification describes techniques to improve air flow and provide better ventilation for flexible substrates, such as fabrics for clothing or other applications, by creating ventilation points on the substrates. The techniques described include treating the flexible substrate with a chemical or combination of chemicals which react to environmental factors such as temperature, moisture, or light. Cuts having predetermined shapes and designs are configured to serve as ventilation points in the flexible substrate in conjunction with the chemical response to environmental factors. The reaction of the chemical treatment to certain environmental factors causes the cuts on the flexible substrate to deform becoming ventilation points on the flexible substrate.

In some cases, the material of the flexible substrate may naturally react to the environment. Where this is the case, a chemical or combination of chemicals may be used to selectively treat the flexible substrate so that its reaction to environmental factors is restricted. The differential in the reaction gradient causes the flexible substrate to deform at predetermined locations, thus, ventilation points on the flexible substrate are also obtained.

### BRIEF DESCRIPTION OF THE DRAWINGS

The accompanying drawings illustrate various embodiments of the present invention and are a part of the specification. The illustrated embodiments are merely examples of the present invention and do not limit the scope of the claims.

FIG. 1 shows an embodiment of the ventilation points formed on a substrate using the process of providing ventilation points on a substrate where the shape of the ventilation point is a V-shape.

FIG. 2 shows the embodiment of the ventilation points of FIG. 1 after the substrate has been exposed to an environmental factor and the tab of the ventilation point is opened up as a reaction to the environment.

FIG. 3 shows an embodiment of the ventilation points formed on a substrate using the process of providing ventilation points on a substrate where the shape of the ventilation point is a perpendicular-cross.

FIG. 4 shows the embodiment of the ventilation points of FIG. 3 after the substrate has been exposed to an environmental factor and the tab of the ventilation point is opened up as a reaction to the environment.

FIG. 5 shows an embodiment of the ventilation points formed on a substrate using the process of providing ventilation points on a substrate where the shape of the ventilation point is a half-circle.

FIG. 6 shows the embodiment of the ventilation points of FIG. 5 after the substrate has been exposed to an environmental factor and the tab of the ventilation point is lifted up as a reaction to the environment.

FIG. 7 shows an embodiment of the ventilation points formed on a substrate using the process of providing ventilation points on a substrate where the shape of the ventilation point is a half-circular.

FIG. 8 shows the embodiment of the ventilation points of FIG. 7 after the substrate has been exposed to an environmental factor and the tab of the ventilation point curls-up as a reaction to the environment.

Throughout the drawings, identical reference numbers designate similar, but not necessarily identical, elements.

### DETAILED DESCRIPTION

The present specification describes a process of providing ventilation points on flexible substrates where the flexible substrate is treated with a chemical or a combination of chemicals and a reaction of the chemical treatment to an environmental factor regulates functioning of the ventilation points prepared on the substrate. The process comprises the steps of substrate selection, chemical selection and chemical preparation, application of the chemical on the substrate and ventilation point creation on the substrate, where the chemical or combination of chemicals used includes but is not limited to chemicals or a combination of chemicals which reacts to environmental factors including temperature, moisture, and light. The reaction of the chemical or combination of chemicals causes the ventilation points prepared on the flexible substrate to deform and adapted to ventilate.

This provides improved air flow and provide better ventilation of the flexible substrates by creating ventilation points on the substrates. As used herein and in the appended claims, the term “substrate” will be used to refer to any flexible substrate or fabric. The substrate is treated with a chemical or combination of chemicals. As used herein and in the appended claims, the term “chemical” will be used to refer to any chemical or combination of chemicals which reacts to one or more environment factors such as temperature, moisture, or light. Once the treated substrate is exposed to an environment factor that reaches a certain level or intensity that the chemical reacts to, the ventilation points that have been prepared on the treated substrate will deform corresponding to their shapes and designs to provide ventilation. The deformation of the ventilation points may be in the form of opening, closing, rolling-up, spreading-apart, lifting-up, and/or bending.

In a particular example, the process of improving ventilation for a substrate by providing ventilation points on the substrate comprises four main steps of (1) selection of the substrate, (2) chemical selection and preparation, (3) application of chemical onto the substrate, and (4) creating the ventilation points on the substrate.

Selecting the Substrate

Preferably, the substrate should be of any flexible material that can be flexed or deformed as a result of the force of the reaction of the chemicals that will be applied on or treated onto the substrate. Examples of such substrates include, but are not limited to, fabric, plastic, canvas, or the like.

Chemical Selection/Preparation

The selection of chemicals that are used for treating the substrate depends on the properties of the chemicals. The chemical selection is determined by the environment the substrate will be exposed to or the completed product incorporating the substrate. For example, if the treated substrate or completed product will be used in an environment with high moisture, a chemical that reacts to certain levels of moisture will be used. If the completed product will be used in an environment with a high temperature, the chemicals that react to certain ranges of high temperatures will be used. If the high temperature is caused by high light intensity, corresponding chemicals that react to ranges of light intensity may be used and so on.

Alternatively, if the substrates are naturally sensitive to an environmental factor such as moisture, the chosen chemical will not necessarily react to that environment. The chemical may be used to restrict the reaction of the substrate with the environment. Such chemical or chemicals are applied to only a selected area or are applied with different concentrations over the entire surface of the substrate resulting in different gradients in reaction rate between the different concentrations of treated and non-treated or less-treated areas. The uneven rate of reaction causes the ventilation points created on the substrate to deform according to predetermined shapes and designs.

For the convenience of substrate treatments, the chemical or combination of chemicals may be prepared in liquid form.

Application of Chemical onto the Substrate

The selected chemicals with required properties, i.e. that react to the corresponding environmental factors that the substrate is intended to encounter, are applied onto the substrate by means of spraying, printing, silk-screening, laminating, or the like. The mode of application of the chemical onto the substrate depends on the type of substrate or its properties or characteristics such as thickness, hardness, softness, texture, absorption ability, etc. Depending on the design of the ventilation points and the type of substrate, the application of the chemical onto the substrate may be applied onto the ventilation points (cut areas) according to the ventilation point's shape or design. The chemical may be applied in a spot application or on the entire sheet of the substrate. It can be applied on only one or both surfaces of the substrate. In addition, it is possible to apply a chemical having one concentration on one surface of the substrate while applying a chemical having a different concentration on another surface. Further, the chemical can be applied in strips or alternate strips of different concentrations.

Creating Ventilation Points on the Substrate

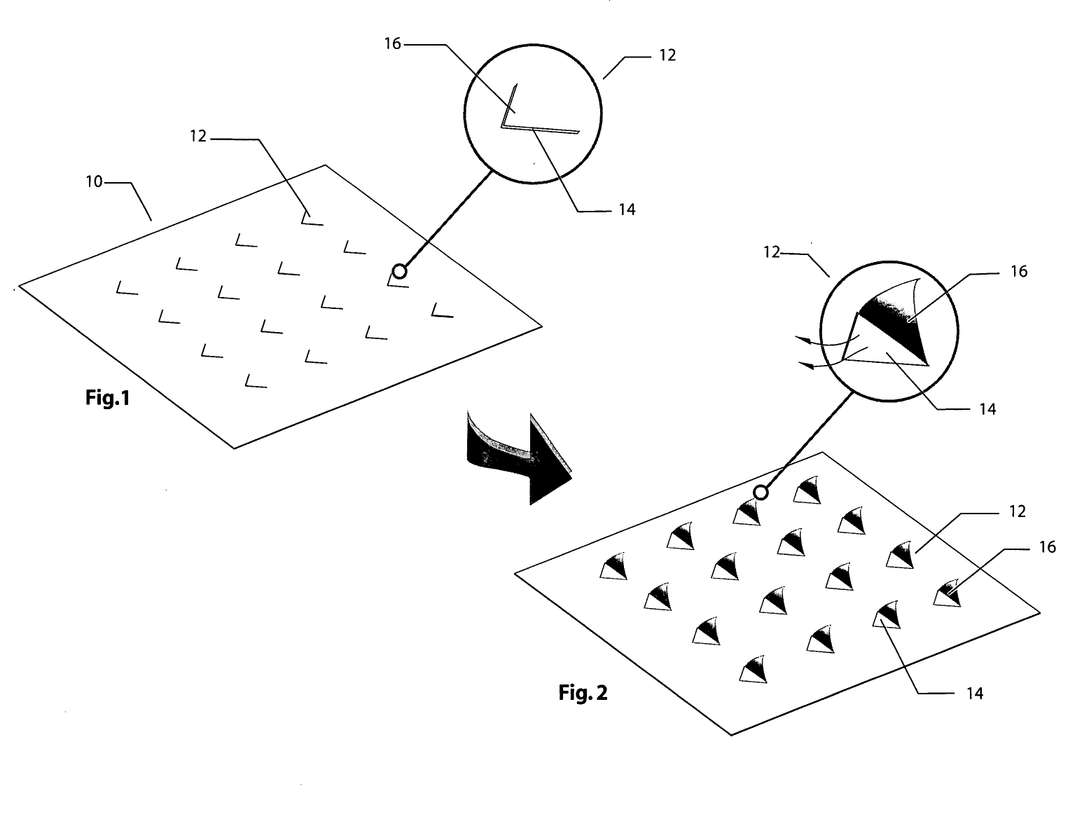

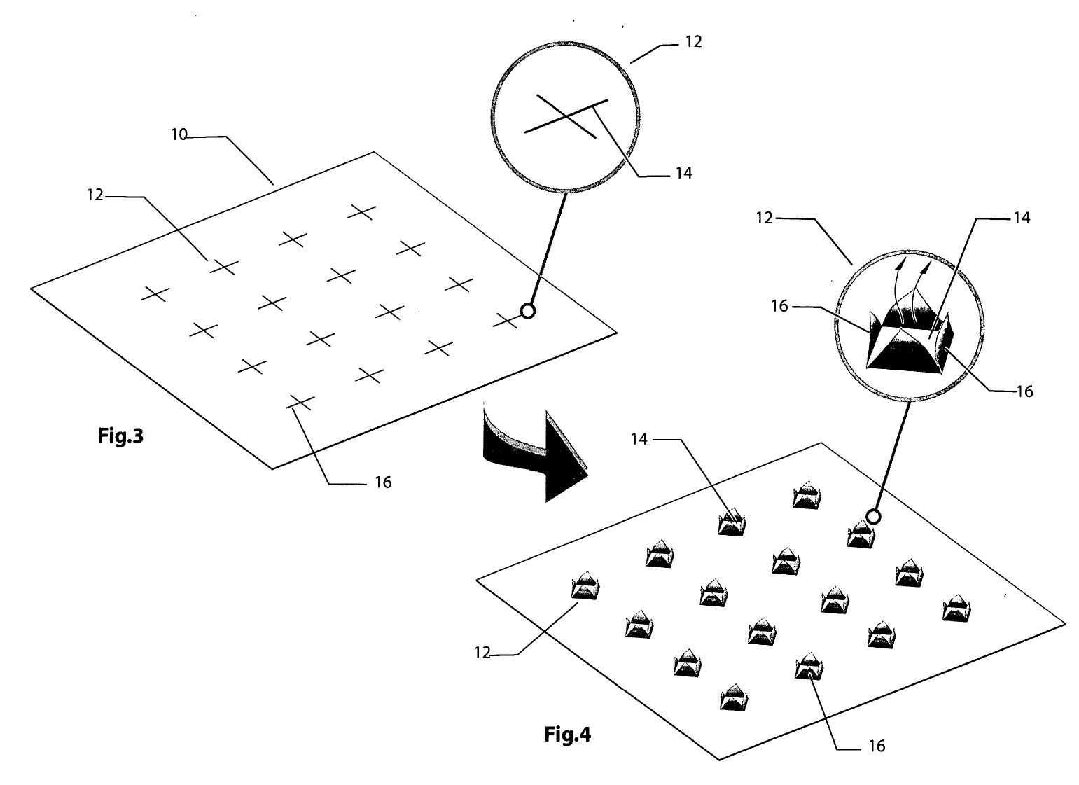

Creating ventilation points on the substrate may be carried out before or after treating the substrate with the chemical. In some examples, the ventilation points on the substrate are created after treating the substrate with the chemical. The shape and design of the ventilation points may be of any desired shape or design such as half circle, half rectangle, star shape, V-shape, U-shape, perpendicular-cross, X-shape, etc. The cuts corresponding to the desired shape and design are then made on the selected areas of the substrate creating ventilation points on the substrate. The cuts may be made manually or automatically. Laser cutting is used in some examples because it reduces fraying on the cuts that form the ventilation points. For example, as shown in FIG. 1 the cuts are made in a V-shape. In another example, shown in FIG. 3, the cuts are made in a perpendicular-cross shape.

As disclosed, after a substrate is chosen and the environment in which the treated substrate will be used is determined, the chemical which reacts to the expected factors of that environment is applied onto the substrate. The mode of chemical application may be chosen depending on the properties and characteristics of the substrate and the shapes and designs of the predetermined ventilation points. The chemical may be applied onto the substrate by spraying, printing, silk screening, or the like. The application may be in the form of a spot, stripe, or on the entire surface of the substrate compatible to the shape and design of ventilation points and the properties and characteristics of the substrate.

After the chemical application is completed, the cuts of the ventilation points are made on the substrate according to the predetermined shape and design. Once the prepared substrates or the products incorporating such substrate are exposed to the environment to which the chemical applied onto the substrate reacts, the reaction of the chemical to the environment or the natural reaction of the substrate (untreated against treated) results in different gradients of reaction or creates tension on the ventilation points urging the ventilation points to deform corresponding to their shape and design. The deformation of the ventilation points may be in a form of curling up, rolling up, opening, spreading apart, or bending. These forms of deformation permit better and faster ventilation providing optimum comfort to the wearer, in the case of clothing articles made from the substrate.

The ventilation points will not deform in normal conditions or if intensity of the environment does not reach that level which triggers the chemical reaction. After the deformation has taken place and either the substrate or the product incorporating the substrate prepared according to this invention is removed from the environment or the environment has changed to a lesser intensity than the chemical will react to, the substrate will return to its original state or shape.

This process is applicable to various types of substrates and thus its uses spread to various types of industries. In the garment industry, the invention may be used in garment or clothing construction in lieu of net-like or open-meshed fabric. This is particularly true in sports wear and outdoor wear where fast ventilation provides greater comfort to the user as body heat exchanges with the normal air temperature quickly cooling the user.

In the housing industry, the invention may be incorporated in a window treatment, such as a shade, blind or drapes, or part of a window or other suitable parts of the house helping to improve air circulation or ventilation of the house. In leisure/recreational industries, the invention may be used with camping equipment such as tents improving air circulation/ventilation or exchange of hot air from inside to outside the tent.

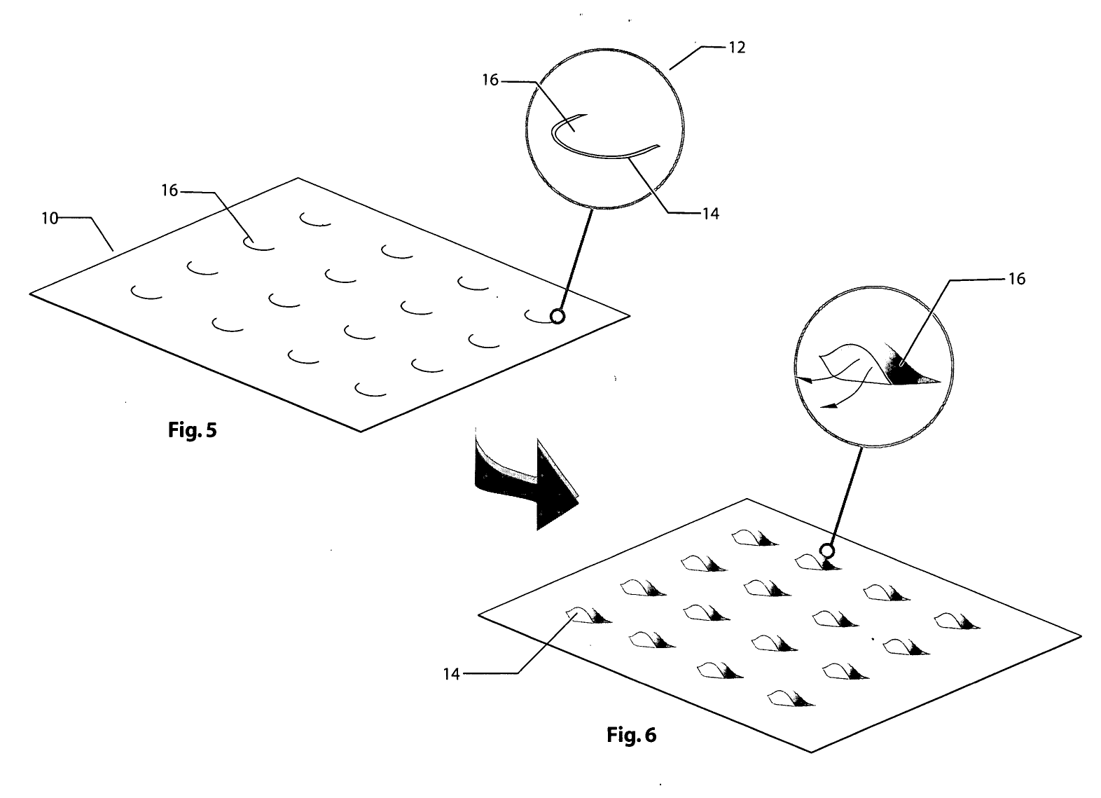

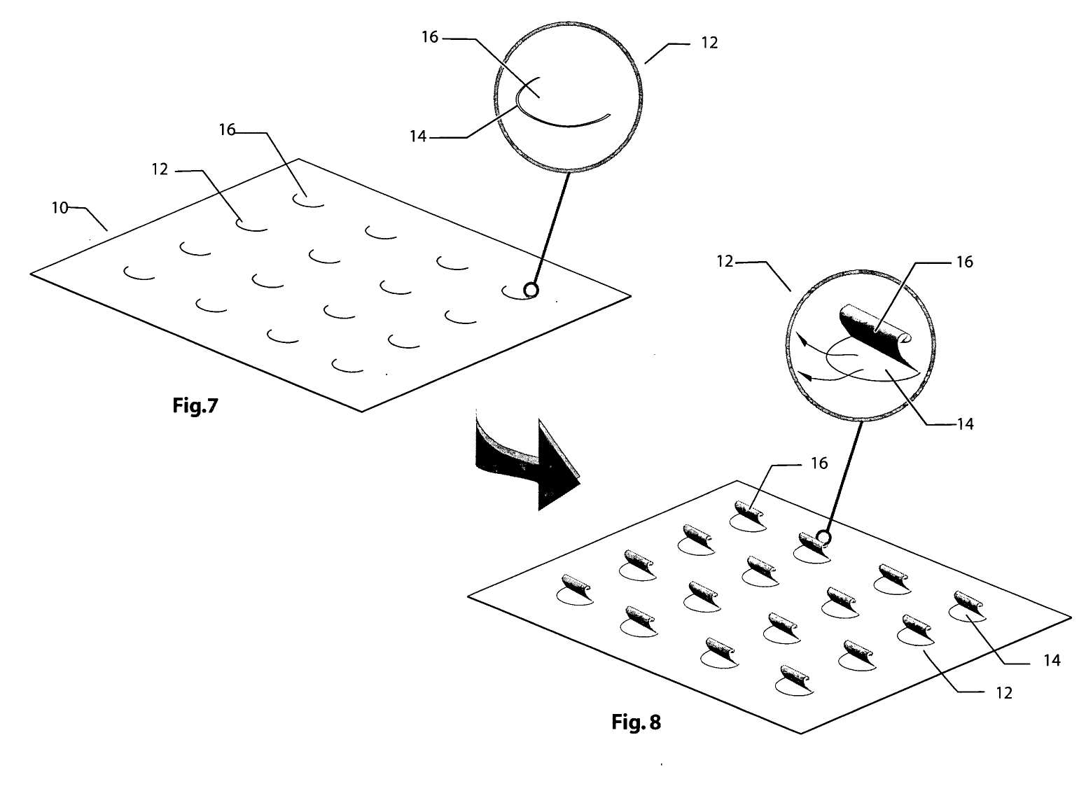

For the purpose of illustration, the process will be described as an example in full detail of which the substrate of use is a fabric and the ventilation point is a half circle shape and shown in FIG. 5. A substrate or fabric (10) is selected. In this example, the fabric (10) is to be used to make articles of clothing that are sensitive to moisture and that ventilate in the presence of a predetermined amount of moisture. Accordingly, a chemical which reacts to moisture such as a hydrophilic polymer is used.

In this example, the shape of the ventilation point (12) is designed to be a half-circle shape as shown in FIG. 5. The intended ventilation points (12) are arranged in rows. Before the ventilation points (12) are formed, the chemical solution is applied, manually or automatically, at the intended locations of the ventilation points (12) in a pattern corresponding to the intended ventilation point's location, shape, and design.

Using a laser beam or other means, half-circle cuts corresponding to the half-circle shape of the intended ventilation points are then made in the fabric (10). The laser cutting results in a small space (14) on the fabric (10) being burnt away by the laser beam, thereby becoming the ventilation point (12). Each ventilation point (12) has a tab (16) generated from the cutting. The tab (16) is, in particular, the area to which the chemical treatment is applied.

Once the prepared fabric (10), with ventilation points (12), is exposed to the anticipated environmental factor, in the example moisture, the chemical reacts causing the tabs (16) to deform, for example, by lifting up as shown in FIG. 6. As a result, the edges of the tab (16) will curl inward causing the middle section of the tab (16) to rise up similar to a dome shape, thereby widening the space (14) created by the laser cutting as shown in FIG. 6. The opening created by the widening of space (14) becomes a ventilation hole that allows a larger amount of air to flow through and thus, improves ventilation of the fabric. If a person wears clothing articles incorporating the fabric prepared by the process according to this invention, and is exposed to moisture, (moisture may be generated through sweating) the tab (16) will deform and the space (14) widens and becomes a ventilation point that allows a larger quantity of air to flow through. Accordingly, the ventilation of the clothes is improved making the user feel more comfortable without the feeling of dampness. Similarly, in hot and humid weather, better ventilation of the clothes keeps the user cool and minimizes sweating. Further and additional shapes and arrangements of the ventilation points prepared according to the principles described herein are shown in FIGS. 2, 4, and 8.

Similarly, thermosensitive and/or photosensitive polymer maybe used if the substrate or a product incorporate the substrate treated is intended to react to temperature and/or light respectively.

The preceding description has been presented only to illustrate and describe embodiments of the invention. It is not intended to be exhaustive or to limit the invention to any precise form disclosed. Many modifications and variations are possible in light of the above teaching.

What is claimed is:

1. A process of providing ventilation points on a flexible substrate comprising:
treating the flexible substrate with a chemical or a combination of chemicals that react to an environmental factor; and
using said reaction to said environmental factor to regulate functioning of the ventilation points prepared on the substrate.

2. The process of claim 1, further comprising
selecting said substrate;
selecting said chemical or combination of chemicals;
applying said chemical or combination of chemicals to said substrate; and
cutting said ventilation points into said substrate.

3. The process of claim 1, wherein said environmental factor includes at least one of temperature, moisture, and light.

4. The process of claim 1, wherein exposure to said environmental factor causes said chemical or combination of chemicals to deform portions of said substrate so as to open said ventilation points.

5. The process of claim 1 further comprising applying different concentrations of said chemical or combination of chemicals over said substrate to create a gradient in reaction rates between different concentrations or between treated and non-treated areas causing the ventilation points created on the substrate to deform according to a predetermined shape and design.

6. The process of claim 1, wherein said environmental factor comprises temperature and said chemical or combination of chemicals comprises a thermosensitive polymer.

7. The process of claim 1, wherein said environmental factor comprises moisture and said chemical or combination of chemicals comprises hydrophilic polymer.

8. The process of claim 1, wherein said environmental factor comprises light and said chemical or combination of chemicals comprises a photosensitive polymer.

9. The process of claim 1, said chemical or combination of chemicals is applied to the substrate by printing, laminating, silk-screening, or hand transferring.

10. The process of claim 1, further comprising selectively applying said chemical or combination of chemicals to said flexible substrate in a pattern corresponding to a location or shape of the ventilation points.

11. The process of claim 1, further comprising applying said chemical or combination of chemicals onto the flexible substrate, wherein a concentration of the chemical or combination of chemicals applied varies over the surface of the substrate.

12. The process of claim 1, further comprising applying said chemical or combination of chemicals to both sides of said substrate.

13. The process of claim 1, further comprising applying said chemical or combination of chemicals is applied onto a surface of the flexible substrate in stripes such that a pattern is formed of alternating treated stripes and non-treated stripes.

14. The process of claim 1, further comprising cutting a ventilation point into said substrate with a shape providing a tab.

15. The process of claim 14, further comprising applying said chemical or combination of chemicals to said tab such that said tab deforms in response to said environmental factor to open the ventilation point.

16. A ventilated substrate comprising
ventilation points in the substrate; and
a chemical or combination of chemicals applied to the substrate that regulate said ventilation points in response to an environmental factor.

17. The substrate of claim 16, wherein said environmental factor comprises any of heat, light and moisture.

18. The substrate of claim 16, wherein said substrate is formed into an article of clothing.

19. The substrate of claim 16, wherein said substrate is formed into a tent.

20. The substrate of claim 16, wherein said substrate is formed into a window treatment.
